(19) United States
(12) Patent Application Publication
(10) Pub. No.: US 2025/0233924 A1
(43) Pub. Date: Jul. 17, 2025

(54) APPLICATION CONTEXT RELOCATION IN EDGE APPLICATIONS

(71) Applicant: HUAWEI TECHNOLOGIES CO., LTD., Shenzhen (CN)

(72) Inventors: Roya EBRAHIM REZAGAH, Kista (SE); Niranth AMOGH, Kista (SE)

(21) Appl. No.: 19/095,332

(22) Filed: Mar. 31, 2025

Related U.S. Application Data
(63) Continuation of application No. PCT/EP2022/082117, filed on Nov. 16, 2022.

(30) Foreign Application Priority Data
Oct. 1, 2022 (IN) 202231056516

(51) Int. Cl. H04L 67/306; H04L 67/14

(52) U.S. Cl. CPC H04L 67/306; H04L 67/14

(57) ABSTRACT

Examples of the disclosure relate to application context relocation (ACR) for edge application data sessions in a communication system. One example method is applied to an edge enabler server (EES). The example method includes receiving an ACR status update from an edge application server (EAS), the ACR status update being associated with an edge application data session between an application client (AC) and the EAS. One or more ACR scenarios is selected for the edge application data session when the ACR status update indicates that the ACR is successful.

### CROSS-REFERENCE TO RELATED APPLICATIONS

This application n is a continuation of International Application No. PCT/EP2022/082117, filed on Nov. 16, 2022, which claims priority to Indian Patent Application No. IN202231056516, filed on Oct. 1, 2022. The disclosures of the aforementioned applications are hereby incorporated by reference in their entireties.

### TECHNICAL FIELD

Examples of the invention relate to handling of application context relocation (ACR) in an edge enabler server (EES) and an edge enabler client (EEC) for edge applications in a communication system. Furthermore, examples of the invention also relate to corresponding methods and a computer program.

### BACKGROUND

3GPP defines an architecture for enabling edge applications which supports service continuity for edge-aware applications. When a user equipment (UE) running an edge application data session moves to a new location, different edge application servers (EASs) can be more suitable for serving the application clients (ACs) in the UE. Generally, the source EAS (S-EAS) is associated with an application context. To support service continuity, the application context associated with the source EAS is transferred to a target EAS (T-EAS). Similarly, an edge enabler client (EEC) context associated with a source edge enabler server (EES) can be transferred to a target EES.

The application context can be moved using an ACR. Currently, five different ACR scenarios have been specified in 3GPP, initiation by EEC using regular EAS discovery, EEC executed ACR via source EES, source EAS decided ACR scenario, source EES executed ACR, and EEC executed ACR via target EES. These ACR scenarios can further be classified depending on the initiator of the ACR into AC-initiated ACR, EAS-initiated ACR, EEC-initiated ACR, and EES-initiated ACR. The EEC, EES and EAS may have the capability to support any of the scenarios.

### SUMMARY

An objective of examples of the invention is to provide a solution which mitigates or solves the drawbacks and problems of conventional solutions.

Another objective of examples of the invention is to provide a solution for triggering and enabling a single entity to select ACR scenarios after an ACR.

The above and further objectives are solved by the subject matter of the independent claims. Further examples of the invention can be found in the dependent claims.

According to a first aspect of the invention, the above mentioned and other objectives are achieved with an EES for a communication system, the EES being configured to:
receive an ACR status update from an EAS, the ACR status update being associated with an edge application data session between an AC and the EAS; and
select one or more ACR scenarios for the edge application data session when the ACR status update indicates that the ACR is successful.

An advantage of the EES according to the first aspect is that it ensures that when an ACR scenario selection is required, the ACR scenario selection is performed and the amount of required signaling for the ACR scenario selection is reduced.

In an implementation form of an EES according to the first aspect, the EES is configured to, previous to selecting the ACR scenario:
receive an EEC context from a serving EES, the EEC context indicating a set of supported and/or previously selected ACR scenarios for the edge application data session; and
select the one or more ACR scenarios from the set of supported and/or previously selected ACR scenarios.

An advantage with this implementation form is that the amount of required signaling to the UE for the ACR scenario selection is reduced.

In an implementation form of an EES according to the first aspect, the EES is configured to:
store the one or more selected ACR scenarios in the EEC context; and/or
store the set of supported and/or previously selected ACR scenarios in the EEC context.

An advantage with this implementation form is that the amount of required signaling for ACR scenario selection is reduced.

In an implementation form of an EES according to the first aspect, the EES is configured to:
select the one or more ACR scenarios for the edge application data session when the ACR status update indicates that the ACR is successful and when the EEC context indicates that an EEC context relocation is successful.

An advantage with this implementation form is that the ACR scenario selection is ensured when required and when sufficient information for the ACR selection exists.

In an implementation form of an EES according to the first aspect, the EES is configured to:
select the one or more ACR scenarios for the edge application data session when the ACR status update indicates that the ACR is successful and when the EEC context indicates that the EEC context relocation is successful and when the EES is allowed to select one or more ACR scenarios for the edge application data session.

An advantage with this implementation form is that a policy for the EES to be allowed to select one or more ACR scenarios ensures that only a single device/entity, in this case the EES, performs the ACR scenario selection, when required and when sufficient information for the ACR selection exists.

In an implementation form of an EES according to the first aspect, the EES is configured to:
receive an ACR scenario message from an EEC when the EES is not allowed to select one or more ACR scenarios for the edge application data session, the ACR scenario message indicating one or more ACR scenarios for the edge application data session; and
transmit an ACR selection notification to the EAS, the ACR selection notification indicating the one or more ACR scenarios for the edge application data session.

An advantage with this implementation form is that all devices/entities within an edge application data session obtain information about the one or more selected ACR scenarios, when the EEC has selected the one or more ACR scenarios.

In an implementation form of an EES according to the first aspect, the EES is configured to:
receive an ACR selection request from an EEC; and
select the one or more ACR scenarios for the edge application data session when the ACR status update indicates that the ACR is successful and when the EEC context indicates that the EEC context relocation is unsuccessful and when the ACR selection request indicates a trigger for the EES to select one or more ACR scenarios for the edge application data session.

An advantage with this implementation form is that the ACR scenario selection is ensured when required and when sufficient information for the ACR scenario selection does not exist within the EES.

In an implementation form of an EES according to the first aspect, the EES is configured to:
select the one or more ACR scenarios for the edge application data session when the ACR status update indicates that the ACR is successful and when the EEC context indicates that the EEC context relocation is unsuccessful and when the ACR selection request indicates the trigger for the EES to select one or more ACR scenarios for the edge application data session and when the EES is allowed to select one or more ACR scenarios for the edge application data session.

An advantage with this implementation form is that a policy for the EES to be allowed to select one or more ACR scenarios ensures that only a single entity, in this case the EES, performs the ACR scenario selection, when required and when sufficient information for the ACR scenario selection does not exist within the EES.

In an implementation form of an EES according to the first aspect, the EES is configured to:
provide an edge data network, EDN, configuration information to an EEC, the EDN configuration information indicating that the EES is allowed or not allowed to select one or more ACR scenarios.

An advantage with this implementation form is that the signaling to the EEC is reduced. Without any additional signaling, the EEC is informed about the policy of the EDN, i.e., whether an EES is allowed or not allowed to select one or more ACR scenarios.

In an implementation form of an EES according to the first aspect, the EES is configured to:
transmit an ACR selection notification to the EAS, the ACR selection notification indicting the one or more selected ACR scenarios for the edge application data session; and
transmit an ACR information notification to the EEC, the ACR information notification indicating the one or more selected ACR scenarios for the edge application data session.

An advantage with this implementation form is that all devices/entities within an edge application data session get information about the one or more selected ACR scenarios, when the EES has selected the one or more ACR scenarios.

According to a second aspect of the invention, the above mentioned and other objectives are achieved with an EEC for a communication system, the EEC being configured to:
receive an ACR information notification from an EES or a serving EES, the ACR information notification being associated with an edge application data session between an AC and an EAS; and:
select one or more ACR scenarios for the edge application data session when the ACR information notification indicates that the ACR is successful and when the EES is not allowed to select one or more ACR scenarios for the edge application data session; or
transmit an ACR selection request to the EES when the ACR information notification indicates that the ACR is successful and that the EEC context relocation is unsuccessful and when the EES is allowed to select one or more ACR scenarios for the edge application data session, the ACR selection request indicating a trigger for the EES to select one or more ACR scenarios for the edge application data session; or
receive an ACR information notification from the EES when the ACR information notification indicates that the ACR is successful and that the EEC context relocation is successful and when the EES is allowed to select one or more ACR scenarios for the edge application data session, the ACR information notification indicating one or more selected ACR scenarios for the edge application data session.

An advantage of the EEC according to the second aspect is that it ensures that when an ACR scenario selection is required, the ACR scenario selection is performed and the amount of required signaling for the ACR scenario selection is reduced.

In an implementation form of an EEC according to the second aspect, the EEC is configured to, upon having selected the one or more ACR scenarios for the edge application data session:
transmit a ACR scenario message to the EES, the ACR scenario message indicating the one or more selected ACR scenarios.

In an implementation form of an EEC according to the second aspect, the EEC is configured to, previous to transmitting the ACR selection request to the EES:
obtain an EDN configuration information from the EES, the EDN configuration information indicating that the EES is allowed or not allowed to select one or more ACR scenarios for the edge application data session.

An advantage with this implementation form is that the signaling to the EEC is reduced. Without additional signaling, the EEC is informed about the policy of the EDN, i.e., whether an EES is allowed or not allowed to select one or more ACR scenarios.

In an implementation form of an EEC according to the second aspect, the EEC is configured to, after having transmitted the ACR selection request to the EES:
receive an ACR information notification from the EES, the ACR information notification indicating one or more selected ACR scenarios for the edge application data session.

According to a third aspect of the invention, the above mentioned and other objectives are achieved with a method for an EES, the method comprises
receiving an ACR status update from an EAS, the ACR status update being associated with an edge application data session between an AC and the EAS; and
selecting one or more ACR scenarios for the edge application data session when the ACR status update indicates that the ACR is successful.

The method according to the third aspect can be extended into implementation forms corresponding to the implementation forms of the EES according to the first aspect. Hence, an implementation form of the method comprises the feature(s) of the corresponding implementation form of the EES.

The advantages of the methods according to the third aspect are the same as those for the corresponding implementation forms of the EES according to the first aspect.

According to a fourth aspect of the invention, the above mentioned and other objectives are achieved with a method for an EEC, the method comprises
receiving an ACR information notification from an EES or a serving EES, the ACR information notification being associated with an edge application data session between an AC and an EAS; and
selecting one or more ACR scenarios for the edge application data session when the ACR information notification indicates that the ACR is successful and when the EES is not allowed to select one or more ACR scenarios for the edge application data session; or
transmitting an ACR selection request to the EES when the ACR information notification indicates that the ACR is successful and that the EEC context relocation is unsuccessful and when the EES is allowed to select one or more ACR scenarios for the edge application data session, the ACR selection request indicating a trigger for the EES to select one or more ACR scenarios for the edge application data session; or
receiving an ACR information notification from the EES when the ACR information notification indicates that the ACR is successful and that the EEC context relocation is successful and when the EES is allowed to select one or more ACR scenarios for the edge application data session, the ACR information notification indicating one or more selected ACR scenarios for the edge application data session.

The method according to the fourth aspect can be extended into implementation forms corresponding to the implementation forms of the EEC according to the second aspect. Hence, an implementation form of the method comprises the feature(s) of the corresponding implementation form of the EEC.

The advantages of the methods according to the fourth aspect are the same as those for the corresponding implementation forms of the EEC according to the second aspect.

Examples of the invention also relate to a computer program, characterized in program code, which when run by at least one processor causes the at least one processor to execute any method according to examples of the invention. Further, examples of the invention also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of examples of the invention will be apparent from the following detailed description.

### BRIEF DESCRIPTION OF THE DRAWINGS

The appended drawings are intended to clarify and explain different examples of the invention, in which:

FIG. 1 shows an EES according to an example of the invention;

FIG. 2 shows a flow chart of a method for an EES according to an example of the invention;

FIG. 3 shows an EEC according to an example of the invention;

FIG. 4 shows a flow chart of a method for an EEC according to an example of the invention;

FIG. 5 shows a communication system according to an example of the invention;

FIG. 6 shows an example of ACR when a UE moves;

FIG. 7 shows EAS triggered ACR scenario selection according to an example of the invention;

FIG. 8 shows ACR scenario selection in the EEC according to an example of the invention; and

FIG. 9 shows EEC triggered ACR scenario selection according to an example of the invention.

### DETAILED DESCRIPTION

Two or more entities may detect and initiate ACR for the same edge application data session at the same time. The EES should reject additional overlapping ACRs and allow only one of the ACRs to continue. In such cases, additional signaling due to extra ACRs and rejecting ACRs are inevitable.

In 3GPP release 18, it is possible to limit the possible ACR scenarios for an edge application data session. Negotiation and decision-making can take place between the EEC, the EES and the EAS, so that all entities have a common list of ACR scenarios. Currently two alternative mechanisms have been captured in 3GPP TR 23.700-98. In alternative 1, the EES determines the ACR scenario(s), upon a request from the EEC. In alternative 2, the EEC determines the EAS and ACR scenario(s) and declares it to the EES. In addition, EAS decided ACR scenario selection and EES decided ACR scenario selection triggered by EAS have been proposed but not agreed.

After the EEC discovers the source EAS information which enables the AC to communicate with the source EAS, the EEC can communicate with the source EES for selection of ACR scenarios using alternative 1 or alternative 2. The source EES hence has the information of the selected ACR scenarios. However, when an ACR happens, the AC/EEC in the UE will be connected to new servers, target EAS and target EES, which may support a different set of ACR scenarios. Thus, the ACR scenarios for the edge application data session, involving AC and target EAS and supported by EEC and target EES, may need to be re-selected and information about the re-selected ACR scenarios provided to the AC, the EEC, the target EES and the target EAS.

According to examples of the invention a solution for trigger and enabling a single entity to perform ACR scenario selection is therefore provided.

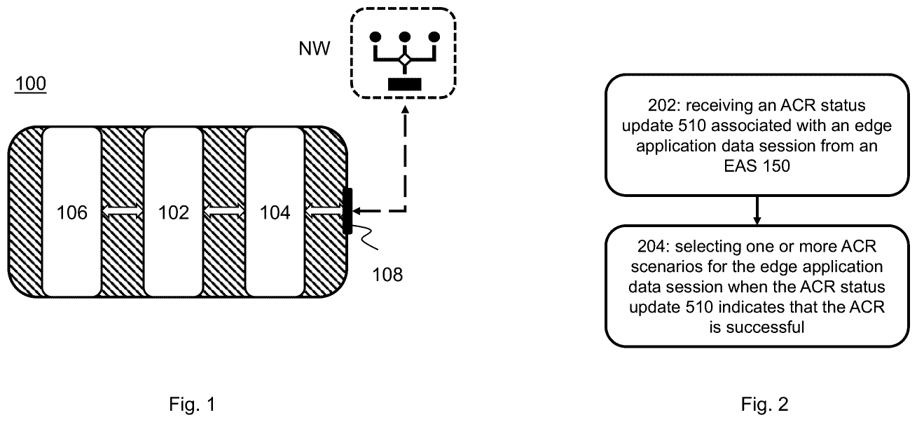

FIG. 1 shows an EES 100 according to an example of the invention. In the example shown in FIG. 1, the EES 100 comprises a processor 102, a transceiver 104 and a memory 106. The processor 102 is coupled to the transceiver 104 and the memory 106 by communication means known in the art. The EES 100 may be configured for wired communications in a communication system. The wired communication capability may be provided with a wired communication interface 108, e.g., coupled to the transceiver 104, over which the EES 100 may communicate with other nodes in a network (NW).

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 104 may be a transceiver circuit, a power controller, or an interface providing capability to communicate with other communication modules or communication devices. The transceiver 104, memory 106 and/or processor 102 may be implemented in separate chipsets or may be implemented in a common chipset.

That the EES 100 is configured to perform certain actions can in this disclosure be understood to mean that the EES 100 comprises suitable means, such as e.g., the processor 102 and the transceiver 104, configured to perform the actions.

According to examples of the invention the EES 100 is configured to receive an ACR status update 510 from an EAS 150, the ACR status update 510 being associated with an edge application data session between an AC 350 and the EAS 150. The EES 100 is further configured to select one or more ACR scenarios for the edge application data session when the ACR status update 510 indicates that the ACR is successful.

Furthermore, in an example of the invention, the EES 100 for a communication system 500 comprises a transceiver configured to: receive an ACR status update 510 from an EAS 150, the ACR status update 510 being associated with an edge application data session between an AC 350 and the EAS 150; and a processor configured to: to select one or more ACR scenarios for the edge application data session when the ACR status update 510 indicates that the ACR is successful.

Moreover, in yet another example of the invention, the EES 100 for a communication system 500 comprises a processor and a memory having computer readable instructions stored thereon which, when executed by the processor, cause the processor to: receive an ACR status update 510 from an EAS 150, the ACR status update 510 being associated with an edge application data session between an AC 350 and the EAS 150; and select one or more ACR scenarios for the edge application data session when the ACR status update 510 indicates that the ACR is successful.

FIG. 2 shows a flow chart of a corresponding method 200 which may be executed in an EES 100, such as the one shown in FIG. 1. The method 200 comprises receiving 202 an ACR status update 510 from an EAS 150, the ACR status update 510 being associated with an edge application data session between an AC 350 and the EAS 150. The method 200 further comprises selecting 204 one or more ACR scenarios for the edge application data session when the ACR status update 510 indicates that the ACR is successful.

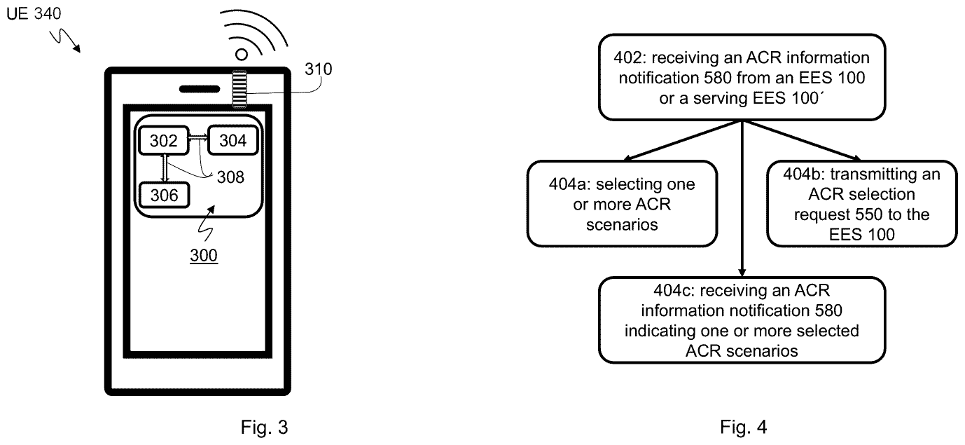

FIG. 3 shows a UE 340 according to an example of the invention comprising an EEC 300. In the example shown in FIG. 3, the UE 340 comprises a processor 302, a transceiver 304 and a memory 306. The processor 302 is coupled to the transceiver 304 and the memory 306 by communication means 308 known in the art. The UE 340 further comprises or is connected to an antenna or antenna array 310 coupled to the transceiver 304, which means that the UE 340 is configured for wireless communications in a communication system. Thus, the EEC 300 may be implemented in the UE 340 as a software running in the UE 340.

The processor 302 may be referred to as one or more general-purpose CPU, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 304 may be a transceiver circuit, a power controller, or an interface providing capability to communicate with other communication modules or communication devices, such as network nodes and network servers. The transceiver 304, the memory 306 and/or the processor 302 may be implemented in separate chipsets or may be implemented in a common chipset.

That the EEC 300 is configured to perform certain actions can in this disclosure be understood to mean that the EEC 300 comprises or is connected to suitable means, such as e.g., the processor 302 and the transceiver 304 of the UE 340, configured to perform the actions.

According to examples of the invention the EEC 300 is configured to receive an ACR information notification 580 from an EES 100 or a serving EES 100′, the ACR information notification 580 being associated with an edge application data session between an AC 350 and an EAS 150. The EEC 300 is further configured to select one or more ACR scenarios for the edge application data session when the ACR information notification 580 indicates that the ACR is successful and when the EES 100 is not allowed to select one or more ACR scenarios for the edge application data session; or transmit an ACR selection request 550 to the EES 100 when the ACR information notification 580 indicates that the ACR is successful and that the EEC context relocation is unsuccessful and when the EES 100 is allowed to select one or more ACR scenarios for the edge application data session, the ACR selection request 550 indicating a trigger for the EES 100 to select one or more ACR scenarios for the edge application data session; or receive an ACR information notification 580 from the EES 100 when the ACR information notification 580 indicates that the ACR is successful and that the EEC context relocation is successful and when the EES 100 is allowed to select one or more ACR scenarios for the edge application data session, the ACR information notification 580 indicating one or more selected ACR scenarios for the edge application data session. The serving EES 100′ may also be denoted source EES.

Furthermore, in an example of the invention, the EEC 300 for a communication system 500 comprises: a transceiver/processor configured to: receive an ACR information notification 580 from an EES 100 or a serving EES 100′, the ACR information notification 580 being associated with an edge application data session between an AC 350 and an EAS 150; and select one or more ACR scenarios for the edge application data session when the ACR information notification 580 indicates that the ACR is successful and when the EES 100 is not allowed to select one or more ACR scenarios for the edge application data session; or transmit an ACR selection request 550 to the EES 100 when the ACR information notification 580 indicates that the ACR is successful and that the EEC context relocation is unsuccessful and when the EES 100 is allowed to select one or more ACR scenarios for the edge application data session, the ACR selection request 550 indicating a trigger for the EES 100 to select one or more ACR scenarios for the edge application data session; or receive an ACR information notification 580 from the EES 100 when the ACR information notification 580 indicates that the ACR is successful and that the EEC context relocation is successful and when the EES 100 is allowed to select one or more ACR scenarios for the edge application data session, the ACR information notification 580 indicating one or more selected ACR scenarios for the edge application data session.

Moreover, in yet another example of the invention, the EEC 300 for a communication system 500 comprises a processor and a memory having computer readable instructions stored thereon which, when executed by the processor, cause the processor to: receive an ACR information notification 580 from an EES 100 or a serving EES 100′, the ACR information notification 580 being associated with an edge application data session between an AC 350 and an EAS 150; and select one or more ACR scenarios for the edge application data session when the ACR information notification 580 indicates that the ACR is successful and when the EES 100 is not allowed to select one or more ACR scenarios for the edge application data session; or transmit an ACR selection request 550 to the EES 100 when the ACR information notification 580 indicates that the ACR is successful and that the EEC context relocation is unsuccessful and when the EES 100 is allowed to select one or more ACR scenarios for the edge application data session, the ACR selection request 550 indicating a trigger for the EES 100 to select one or more ACR scenarios for the edge application data session; or receive an ACR information notification 580 from the EES 100 when the ACR information notification 580 indicates that the ACR is successful and that the EEC context relocation is successful and when the EES 100 is allowed to select one or more ACR scenarios for the edge application data session, the ACR information notification 580 indicating one or more selected ACR scenarios for the edge application data session.

FIG. 4 shows a flow chart of a corresponding method 400 which may be executed in a network access node 300, such as the one shown in FIG. 3. The method 400 comprises receiving 402 an ACR information notification 580 from an EES 100 or a serving EES 100′, the ACR information notification 580 being associated with an edge application data session between an AC 350 and an EAS 150. The method 400 further comprises selecting 404a one or more ACR scenarios for the edge application data session when the ACR information notification 580 indicates that the ACR is successful and when the EES 100 is not allowed to select one or more ACR scenarios for the edge application data session; or transmitting 404b an ACR selection request 550 to the EES 100 when the ACR information notification 580 indicates that the ACR is successful and that the EEC context relocation is unsuccessful and when the EES 100 is allowed to select one or more ACR scenarios for the edge application data session, the ACR selection request 550 indicating a trigger for the EES 100 to select one or more ACR scenarios for the edge application data session; or receiving 404c an ACR information notification 580 from the EES 100 when the ACR information notification 580 indicates that the ACR is successful and that the EEC context relocation is successful and when the EES 100 is allowed to select one or more ACR scenarios for the edge application data session, the ACR information notification 580 indicating one or more selected ACR scenarios for the edge application data session.

An ACR scenario may be understood to be a type of ACR defined by who initiates the ACR and/or how the ACR is performed. The ACR scenarios may e.g., be differentiated from each other by one or more of the following factors: the device/entity that detects the need for AC; the device/entity that decides that an ACR is required; the device/entity that initiates the ACR, the device(es)/entity(ies) that executes the ACR, the way that the ACR is performed, e.g., the communicated messages and the order of the messages.

Each of the AC, the EEC, the EES and the EAS may support zero, one or more of the ACR scenarios. A negotiation may happen between the EEC, the EES and the EAS, so that all device/entities have a common list of the one or more selected ACR scenarios for the session between AC-EEC-EES-EAS. The one or more selected ACR scenarios are supported by all of the AC, the EEC, the EES and the EAS. When there is no ACR scenario that is supported by all of the AC, the EEC, the EES and the EAS, no ACR scenario can be selected and thus no ACR is possible.

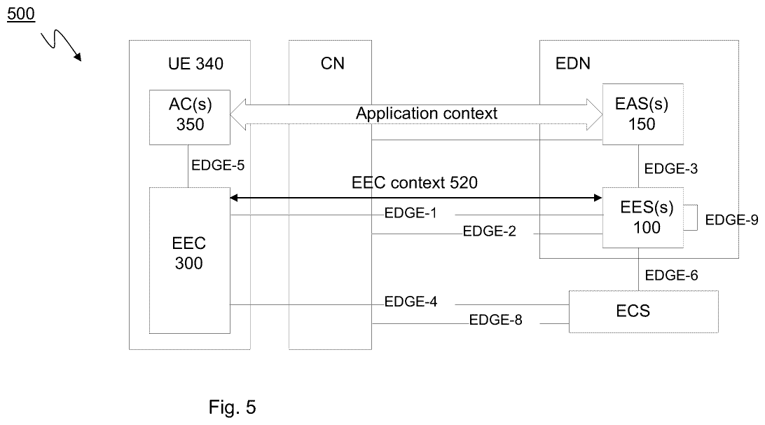

FIG. 5 shows a communication system 500 for enabling edge applications according to an example of the invention. The communication system 500 may be a communication system according to the 3GPP standard such as e.g., a 5G system. The communication system 500 in the disclosed example comprises the UE 340, a core network (CN), an edge data network (EDN) and an edge configuration server (ECS) configured to communicating with each other over EDGE interfaces (EDGE-1, EDGE-2, etc.) to provide edge application services in the communication system 500. The UE 340 comprises one or more ACs 350 and an EEC 300 and the EDN comprises one or more EASs 150 and one or more EESs 100. With reference to FIG. 5, the one or more ACs 350 in the UE 340 may communicate with the one or more EASs 150 over the CN and be associated with an application context. The EEC 300 in the UE 340 may communicate with the one or more EESs 100 over the CN and be associated with an EEC context 520.

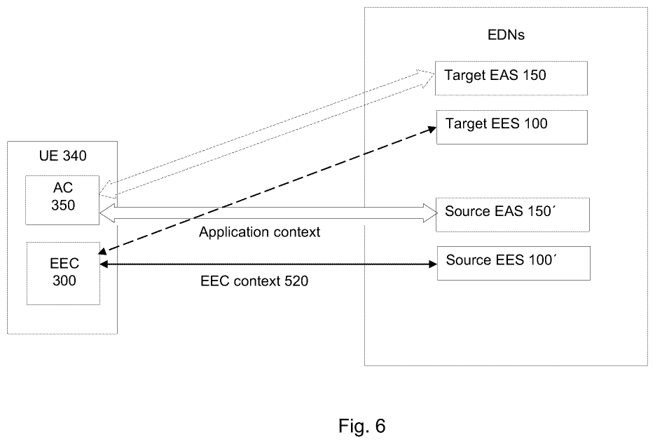

With reference to FIG. 6, when a UE 340 with an active application context and EEC context 520 associated with a source EAS 150′ and a source EES 100′ and the EEC 300 moves to a new location, different EASs 150 and EESs 100 may be more suitable to serve the ACs 350 and EEC 300 in the UE 340. The application context may hence be transferred from the source EAS 150′ to a target EAS 150 using an ACR procedure. Similarly, the EEC context 520 may be transferred from the source EES 100′ to a target EES 100. The AC and the EEC context may be associated with corresponding communication links.

For actions like ACR that involve multiple entities in the UE 340 and EDN, negotiation and determination of capabilities between the entities are required. The AC 350 and the EEC 300 in the UE 340 and the EAS 150 and the EES 100 in the EDN may e.g., support different capabilities related to ACR. An example of such capabilities is which ACR scenarios are supported. Consequently, there is a need to provide a solution which can trigger capability negotiations when required. For example, after ACR when the UE 340 connects to new network entities that may have different capabilities. Furthermore, it would be beneficial to assure that one single entity determines the capabilities supported by all the entities and all involved entity are aware of which entity is the one making the determination.

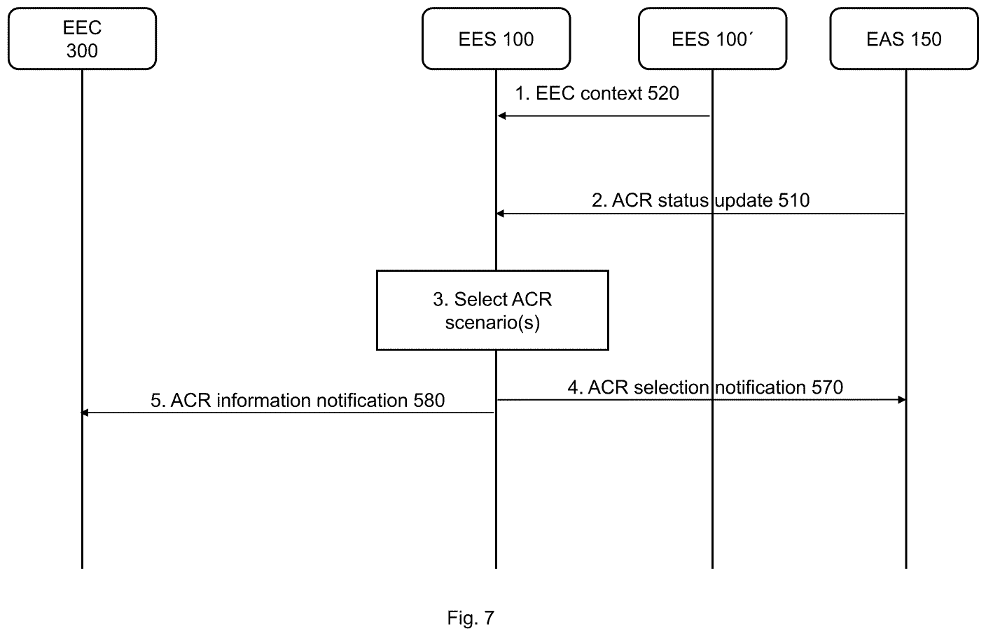

According to examples of the invention the EES 100 is therefore enabled to upon an indication of a successful ACR select one or more ACR scenarios in negotiation with the EEC 300, as will now be described with reference to FIGS. 7 to 9.

Generally, in examples of the invention ACR scenario selection may be replaced by, or being equivalent to selecting capabilities related to the ACR. Hence, instead of the selection of one or more ACR scenarios, a list of one or more capabilities may be selected. For example, the list of such selected one or more capabilities can be any combination of: one or more devices/entities that are capable and are selected to detect the need for an ACR; one or more devices/entities that are capable and are selected to decide that the ACR is required; one or more devices/entities that are capable and are selected to initiate the ACR, and one or more devices/entities that are capable and are selected to execute the ACR.

FIG. 7 shows EAS 150 triggered ACR scenario selection in an EES 100 according to an example of the invention. The EAS ACR scenario selection may comprise signaling between the EEC 300, the EES 100 and the EAS 150. The EAS 150 may be a target EAS and the EES 100 may be a target EES, i.e., entities associated with the edge application data session after the ACR.

In step 1 in FIG. 7, the EES 100 receives an EEC context 520 from a serving EES 100′. The EEC context 520 indicates or comprises a set of supported and/or previously selected ACR scenarios for the edge application data session.

In step 2 in FIG. 7, the EES 100 receives an ACR status update 510 from the EAS 150. The ACR status update 510 is associated with an edge application data session between an AC 350 and the EAS 150. The ACR status update 510 may indicate that the ACR is successful or unsuccessful. In the shown example, it is assumed that the ACR is successful, i.e., the application context has successfully been transferred from a serving EAS 150′ to the EAS 150, and that the EES 100 is triggered to perform ACR capability re-selection.

In step 3 in FIG. 7, the EES 100 selects one or more ACR scenarios for the edge application data session when the ACR status update 510 indicates that the ACR is successful. In the selection, the EES 100 may consider one or more of: its own capability, EEC 300 capability and/or AC 350 capability and preference from the EEC context 520, target EAS 150 registered capabilities and optionally previously selected ACR scenarios. Based on the capabilities and/or previously selected ACR scenarios, the EES 100 may determine ACR scenarios that are supported by the entities involved in the edge application data session. The EES 100 may then select one or more ACR scenarios from the supported ACR scenarios. The EES 100 may e.g., filter the supported ACR scenarios and select a subset of the supported ACR scenarios. The subset of the supported ACR scenarios may e.g., include fewer than all supported ACR scenarios or only one of the supported ACR scenarios. If there is no possible ACR scenario, e.g., if no ACR scenario supported by all involved entities can be found, no ACR scenario may be selected. This case may be referred to as a zero ACR scenario selection and the set of selected ACR scenarios by the EES 100 may in this case be an empty set. When no possible ACR scenarios can be found, ACR may no longer be possible for the edge application data session. In other words, ACR may not be supported anymore for the edge application data session.

If the EES 100 receives an EEC context 520 indicating a set of supported and/or previously selected ACR scenarios from the serving EES 100′ previous to selecting the ACR scenario, i.e., step 1 in FIG. 7, the EES 100 may select the one or more ACR scenarios from the set of supported and/or previously selected ACR scenarios.

In examples, the EES 100 stores the one or more selected ACR scenarios in the EEC context 520. The stored one or more selected ACR scenarios may be used in a subsequent ACR to indicate previously selected ACR scenarios. For example, when the EES 100 has become a serving EES 100′ and a new ACR is triggered, the stored one or more selected ACR scenarios may be forwarded to a new target EES 100 with the EEC context 520. The new target EES 100 can thereby be informed about the ACR scenarios previously selected and stored during an earlier ACR.

The EES 100 may further store the set of supported and/or previously selected ACR scenarios in the EEC context 520. For example, the EES 100 may store the set of supported and/or previously selected ACR scenarios received from the serving EES 100′ in the EEC context 520 in step 1 in FIG. 7. The EES 100 may further receive information from the EEC 300 about its supported and/or preferred ACR scenarios during e.g., ACR, registration, and EAS discovery. The EES 100 may then update the EEC context 520 to store this information in the EEC context 520.

By storing this information in the EEC context 520, the EEC context 520 is enhanced and can provide information about the ACR scenarios supported by the AC 350, the EEC 300, the EES 100 and the EAS 150, as well as previously selected ACR scenarios for the edge application data session between the AC 350 and the EAS 150. Information about supported and/or previously selected ACR scenarios can thereby be transferred to the target EES 100 during the ACR, without additional signaling.

During the selection in step 3 in FIG. 7 the EES 100 may consider one or more conditions related to whether the ACR and/or the EEC context relocation are successful or not and whether the EES 100 is allowed to perform ACR scenario selection or not. For example, the EES 100 may select the one or more ACR scenarios for the edge application data session when the ACR status update 510 indicates that the ACR is successful and when the EEC context 520 indicates that an EEC context relocation is successful. That the ACR is successful may be understood as that the application context has been successfully transferred from the source/serving EAS 150′ to the target EAS 150 and that the UE 340 through the AC 350/EEC 300 now can communicate with the T-EES 100/T-EAS 150. The EES 100 may receive the EEC context 520 from the serving EES 100′, as shown in step 1 in FIG. 7, and the reception of the EEC context 520 may indicate that the EEC context relocation was successful. In other words, the EES 100 may determine that the EEC context relocation is successful, when the EEC context 520 is received successfully/correctly. That the EEC context relocation is successful may be understood to mean that the EEC context relocation has succeeded and that the EEC context 520 indicates or includes a set of supported and/or previously selected ACR scenarios.

In addition to whether the ACR and the EEC context relocation are successful, the EES 100 may further consider whether it is allowed to select one or more ACR scenarios for the edge application data session or not. In examples, the EES 100 may hence selects the one or more ACR scenarios for the edge application data session when the ACR status update 510 indicates that the ACR is successful and when the EEC context 520 indicates that the EEC context relocation is successful and when the EES 100 is allowed to select one or more ACR scenarios for the edge application data session.

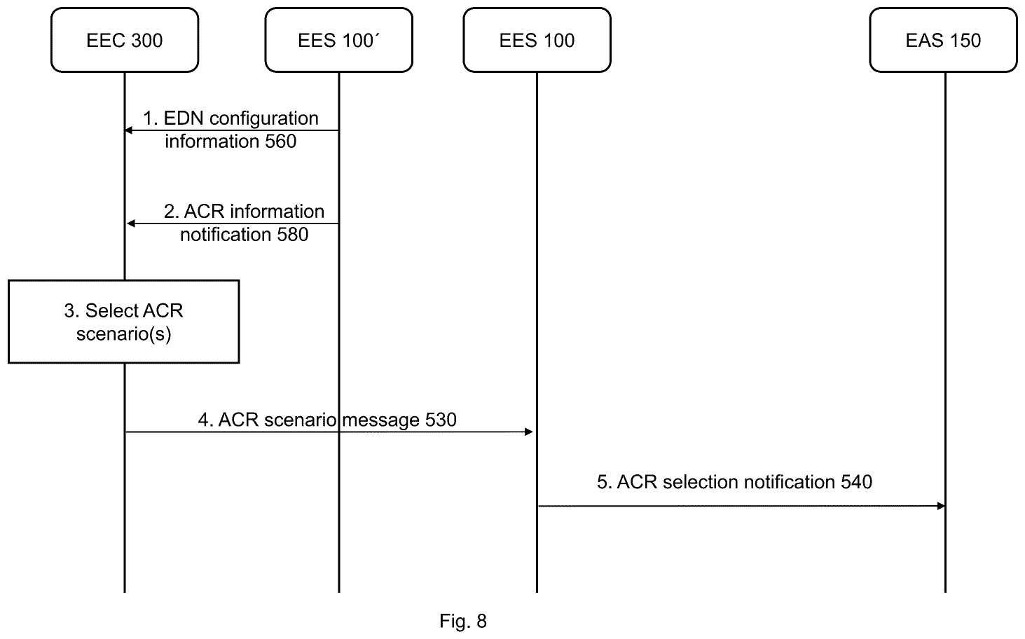

On the other hand, when the EES 100 is not allowed to select one or more ACR scenarios for the edge application data session, the EES 100 may instead of selecting ACR scenarios receive one or more ACR scenarios from the EEC 300 and indicate the received one or more ACR scenarios to the EAS 150. This scenario is described below with reference to FIG. 8.

Whether the EES 100 is allowed or not allowed to select ACR scenarios may be determined by policies, e.g., policies configured on the EES 100 by a management system. These policies are not known by the EEC 300; and the EES 100 may hence inform the EEC 300 whether the EES 100 is allowed or not allowed to select ACR scenarios. In examples, the EES 100 provides this information to the EEC 300 by providing an EDN configuration information 560 to the EEC 300, the EDN configuration information 560 indicating that the

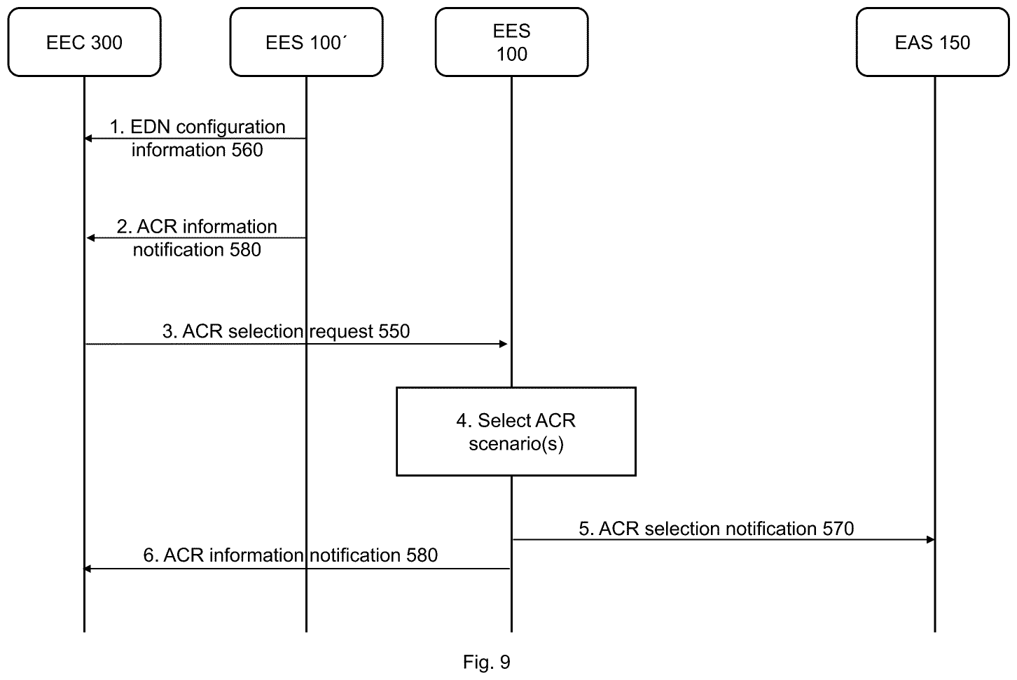

EES 100 is allowed or not allowed to select one or more ACR scenarios, as shown in step 1 of FIGS. 8 and 9, respectively. The EES 100 may provide this information to the EEC 300 directly or via a serving EES 100′ or via a configuration server, e.g., an ECS. Furthermore, the EDN configuration information 560 may be comprised in the below described ACR information notification 580 from the EES 100 to the EEC 300.

In an example of the invention, the EDN configuration information 560 of the EES 100 may be sent to the EEC 300 by or via the serving EES 100′. In another example, the EDN configuration information 560 may be sent to the EEC 300 by or via an edge configuration server (ECS). Basically, before the EEC 300 connects to the EES 100, the EEC 300 may receive EDN configuration information 560 of the EES 100, as explained previously, from the serving EES 100′ or from the ECS. Thus, the EES 100 provides the EDN configuration information 560 when it registers itself to the ECS. Two main options are available:
A) the serving EES 100′ discovers the EES 100 from the ECS and obtains the EDN configuration information 560 of the EES 100 and the serving EES 100′ transmits this information to the EEC 300, e.g., through a target information notification; or
B) the EEC 300 discovers the EES 100 from the ECS e.g., by using provisioning request message to the ECS and obtains the EDN configuration information 560 of the EES 100.

Whatever option A or B is happening may depend on the ACR scenario that is being executed. In different ACR scenarios, the serving EES 100′ or the EEC 300 has the role to find the EES 100.

With reference to FIG. 7, when the one or more ACR scenarios has been selected, the EES 100 transmits an ACR selection notification 570 to the EAS 150 in step 4 in FIG. 7. The ACR selection notification 570 indicates the one or more selected ACR scenarios for the edge application data session. The EES 100 further transmits an ACR information notification 580 to the EEC 300 in step 5 in FIG. 7. The ACR information notification 580 indicates the one or more selected ACR scenarios for the edge application data session. In this way, both the EAS 150 and the EEC 300 are informed about the one or more selected ACR scenarios for the edge application data session. The selected ACR scenarios may be different to the previously selected ACR scenarios or the same, either way the EES 100 may indicate the selected ACR scenarios to the EEC 300 and EAS 150.

In the shown example, the EEC 300 receives the ACR information notification 580 from the EES 100 when the ACR information notification 580 indicates that the ACR is successful and that the EEC context relocation is successful and when the EES 100 is allowed to select one or more ACR scenarios for the edge application data session. The ACR information notification 580 indicating the one or more selected ACR scenarios for the edge application data session, i.e., the one or more ACR scenarios selected by the EES 100 in step 3 in FIG. 7.

FIG. 8 shows ACR scenario selection in the EEC 300 according to an example of the invention. The ACR scenario selection may comprise signaling between the EEC 300, the EAS 150, the EES 100 and the serving EES 100′. The EAS 150 may be a target EAS and the EES 100 may be a target EES, i.e., entities to which the edge application data session is moved or is being moved.

The ACR scenario selection may be performed in the EEC 300 when the EES 100 is not allowed to select ACR scenarios for the edge application data session. The EEC 300 may obtain information that the EES 100 is not allowed to select ACR scenarios by obtaining an EDN configuration information 560 from the EES 100. In the example shown in FIG. 8, the EEC 300 receives the EDN configuration information 560 from the serving EES 100′, as shown in step 1 in FIG. 8. The EDN configuration information 560 indicating that the EES 100 is not allowed to select one or more ACR scenarios.

Although shown as a separate step in FIG. 8, the EDN configuration information 560 may be comprised in the ACR information notification 580 received in step 2 in FIG. 8. In examples, the EEC 300 may hence receive the EDN configuration information 560 as part of the ACR information notification 580. Furthermore, the EEC 300 may receive the EDN configuration information 560 from the EES 100 directly, via another EES 100′, or via a configuration server, e.g., an ECS. Thus, in step 2 in FIG. 8, the EEC 300 receives an ACR information notification 580 from the serving EES 100′, the ACR information notification 580 being associated with an edge application data session between the AC 350 and the EAS 150. Alternatively, the EEC 300 may receive the ACR information notification 580 from the EES 100. Which entity the EEC 300 receives the ACR information notification 580 from may depend on the ACR scenario that is executed.

When the ACR information notification 580 indicates that the ACR is successful and the EES 100 is not allowed to select ACR scenarios, the EEC 300 selects one or more ACR scenarios for the edge application data session in step 3 in FIG. 8. Upon having selected the one or more ACR scenarios for the edge application data session, the EEC 300 transmit a ACR scenario message 530 to the EES 100 in step 4 in FIG. 8. The ACR scenario message 530 indicates the one or more selected ACR scenarios. The EES 100 receives the ACR scenario message 530 from the EEC 300 and hence obtains the indication of the one or more ACR scenarios selected by the EEC 300.

In step 5 in FIG. 8, the EES 100 transmits an ACR selection notification 540 to the EAS 150, the ACR selection notification 540 indicating the one or more ACR scenarios for the edge application data session. In this way, the EES 100 informs the EAS 150 about the one or more ACR scenarios selected by the EEC 300.

FIG. 9 shows EEC triggered ACR scenario selection according to an example of the invention, where the EES 100 is allowed to select one or more ACR scenarios for the edge application data session.

The EEC 300 may obtain the information that the EES 100 is allowed to select ACR scenarios by obtaining an EDN configuration information 560, as shown in step 1 in FIG. 9. The EDN configuration information 560 indicates that the EES 100 is allowed to select ACR scenarios from the EES 100. As previously described, the EEC 300 may receive the EDN configuration information 560 as part of the ACR information notification 580 and further from the EES 100 directly, via another EES 100′, or via a configuration server, e.g., an ECS.

In step 2 in FIG. 9, the EEC 300 receives an ACR information notification 580 associated with an edge application data session between the AC 350 and the EAS 150. As described with reference to step 2 in FIG. 8, the EEC 300 may receive the ACR information notification 580 from the EES 100 or from the serving EES 100′.

When the ACR information notification 580 indicates that the ACR is successful and that the EEC context relocation is unsuccessful and when the EES 100 is allowed to select ACR scenarios, the EEC 300 transmits an ACR selection request 550 to the EES 100 in step 3 in FIG. 9. The ACR selection request 550 indicates a trigger for the EES 100 to select one or more ACR scenarios for the edge application data session. The ACR selection request 550 may further include supported ACR scenarios and/or preferred ACR scenarios by the EEC 300. As shown in FIG. 9, the EEC 300 may obtain information that the EES 100 is allowed to select one or more ACR scenarios from the EDN configuration information 560 from the EES 100, previous to transmitting the ACR selection request 550.

The EES 100 receives the ACR selection request 550 from the EEC 300 and select one or more ACR scenarios for the edge application data session in step 4 in FIG. 9. The selection in step 4 in FIG. 9, may be based on an ACR status update 510, an EEC context 520 and the received ACR selection request 550, as described with reference to FIG. 7. In examples, the EES 100 selects one or more ACR scenarios, when the ACR status update 510 indicates that the ACR is successful and when the EEC context 520 indicates that the EEC context relocation is unsuccessful and when the ACR selection request 550 indicates a trigger for the EES 100 to select one or more ACR scenarios for the edge application data session. That the EEC context relocation is unsuccessful may be understood to mean that the EEC context relocation has failed or that the EEC context relocation was successful, but the EEC context 520 does not include a set of supported and/or previously selected ACR scenarios.

The selection in step 4 in FIG. 9, may further be based on the EES 100 being allowed to select one or more ACR scenarios for the edge application data session. In examples, the EES 100 may hence select the one or more ACR scenarios for the edge application data session when the ACR status update 510 indicates that the ACR is successful and when the EEC context 520 indicates that the EEC context relocation is unsuccessful and when the ACR selection request 550 indicates the trigger for the EES 100 to select one or more ACR scenarios for the edge application data session and when the EES 100 is allowed to select one or more ACR scenarios for the edge application data session.

When the one or more ACR scenarios has been selected, the EES 100 transmits an ACR selection notification 570 indicting the one or more selected ACR scenarios for the edge application data session to the EAS 150 in step 5 in FIG. 9. The EES 100 further transmits an ACR information notification 580 indicting the one or more selected ACR scenarios for the edge application data session to the EEC 300 in step 6 in FIG. 9. Thus, after having transmitted the ACR selection request 550 to the EES 100, the EEC 300 receive the ACR information notification 580 from the EES 100 and hence the informed about the ACR scenarios selected by the EES 100.

Further details related to the signaling and messages according to examples of the invention will now be described in a 3GPP 5G context.

The EEC context relocation according to the 3GPP standard is enhanced by storing/adding additional information related to supported ACR scenarios and/or previously selected ACR scenarios to the EEC context 520. By storing this information in the EEC context 520, the EEC context 520 is enhanced and can provide information about the ACR scenarios supported by the AC 350, the EEC 300, the EES 100 and the EAS 150, as well as previously selected ACR scenarios for the edge application data session between the AC 350 and the EAS 150. Information about supported and/or previously selected ACR scenarios can thereby be transferred to the target EES 100 during ACR, without additional signaling.

The EDN configuration information 560 may be implemented as an enhanced EDN configuration information according to the 3GPP standard. For example, a new or updated information clement (IE) may be used in the enhanced EDN configuration information. The new or updated IE may indicate whether the EES 100 is capable of performing ACR capabilities determination and hence ACR scenario selection and/or whether the EES 100 is allowed to determine the ACR capabilities based on policies or not. Table 1 shows an example where the existing EES service continuity support IE in the EDN configuration information according to the 3GPP standard has been updated to provide this information.

TABLE 1

| Information | | |
|---|---|---|
| element | Status | Description |
| > EES Service | O | Indicates if the EES supports service |
| continuity | | continuity or not. This IE also indicates |
| support | | which ACR scenarios are supported by the |
| | | EES. According to examples of the |
| | | invention this IE further indicates if the |
| | | EES is allowed or not allowed to select |
| | | ACR scenarios, e.g., after ACR. |

The EDN configuration information 560 may be comprised in an “target information notification” and/or “service provisioning response” according to the 3GPP standard. The additional information in the EDN configuration information 560 can thereby be provided to the EEC 300 in the UE 340 during e.g., provisioning of the EEC 300 and EAS 150 discovery by the EEC 300.

According to the 3GPP standard the ACR information notification from a serving EES or target EES to an EEC includes two notifications: “ACR complete notify” and “target information notification”. The “target information notification” is used when during an ACR the target EES and target EAS are determined and selected by an entity in the network, i.e., a source EES or a source EAS. In that case, this notification is sent to the EEC (on the UE) to inform it about the selected target EES and/or target EAS, as defined in 3GPP TS 23.558. This notification is used within source EAS decided ACR scenario and source EES executed ACR scenario. The “Target information notification”, under target EES information field, includes the EDN configuration information IE. With the enhanced EDN configuration information 560 according to examples of the invention information whether the target EES is capable and allowed to, e.g., based on policies, determine the new ACR capabilities after the successful end of the ACR can be provided to the EEC.

The “ACR complete notify” is an existing notification defined in 3GPP TS 23.558. The notification is from a target EES to an EEC in case of EEC executed ACR via target EES. Otherwise, the notification is from a source EES to an EEC. The notification includes the result of application context transfer (ACT) between a source EAS and a target EAS. The notification also includes the result of EEC context transfer between a source EES and a target EES.

In examples of the invention, “ACR complete notify” can be enhanced by adding information about the policy and capability of a target EES 100, e.g., whether the target EES 100 is capable to perform ACR scenario selection, and/or whether the target EES 100 is allowed to select ACR scenarios based on policies.

Furthermore, any method according to examples of the invention may be implemented in a computer program, having code means, which when run by processing means causes the processing means to execute the steps of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the EES 100 and the EEC 300 may comprise the necessary communication capabilities in the form of e.g., functions, means, units, elements, etc., for performing or implementing examples of the invention. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) in which the EES 100 and the EEC 300 are executed may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the examples described above, but also relates to and incorporates all examples within the scope of the appended independent claims.

1. An edge enabler server (EES) for a communication system, comprising:
at least one processor; and
one or more memories coupled to the at least one processor and storing programming instructions for execution by the at least one processor to:
receive an application context relocation (ACR) status update from an edge application server (EAS), the ACR status update being associated with an edge application data session between an application client (AC) and the EAS; and
select one or more ACR scenarios for the edge application data session when the ACR status update indicates that the ACR is successful.

2. The EES according to claim 1, wherein the programming instructions are for execution by the at least one processor to, prior to selecting the ACR scenario:
receive an edge enabler client (EEC) context from a serving EES, the EEC context indicating at least one of a set of supported or previously selected ACR scenarios for the edge application data session; and
select the one or more ACR scenarios from at least one of the set of supported or previously selected ACR scenarios.

3. The EES according to claim 2, wherein the programming instructions are for execution by the at least one processor to at least one of:
store the one or more selected ACR scenarios in the EEC context; or
store at least one of the set of supported or previously selected ACR scenarios in the EEC context.

4. The EES according to claim 2, wherein the programming instructions are for execution by the at least one processor to:
select the one or more ACR scenarios for the edge application data session when:
the ACR status update indicates that the ACR is successful; and
the EEC context indicates that an EEC context relocation is successful.

5. The EES according to claim 4, wherein the programming instructions are for execution by the at least one processor to:
select the one or more ACR scenarios for the edge application data session when:
the ACR status update indicates that the ACR is successful;
the EEC context indicates that the EEC context relocation is successful; and
the EES is allowed to select one or more ACR scenarios for the edge application data session.

6. The EES according to claim 4, wherein the programming instructions are for execution by the at least one processor to:
receive an ACR scenario message from an EEC when the EES is not allowed to select one or more ACR scenarios for the edge application data session, the ACR scenario message indicating one or more ACR scenarios for the edge application data session; and
transmit an ACR selection notification to the EAS, the ACR selection notification indicating the one or more ACR scenarios for the edge application data session.

7. The EES according to claim 2, wherein the programming instructions are for execution by the at least one processor to:
receive an ACR selection request from an EEC; and
select the one or more ACR scenarios for the edge application data session when:
the ACR status update indicates that the ACR is successful;
the EEC context indicates that an EEC context relocation is unsuccessful; and
the ACR selection request indicates a trigger for the EES to select one or more ACR scenarios for the edge application data session.

8. The EES according to claim 7, wherein the programming instructions are for execution by the at least one processor to:
select the one or more ACR scenarios for the edge application data session when:
the ACR status update indicates that the ACR is successful;
the EEC context indicates that the EEC context relocation is unsuccessful;
the ACR selection request indicates the trigger for the EES to select one or more ACR scenarios for the edge application data session; and
the EES is allowed to select one or more ACR scenarios for the edge application data session.

9. The EES according to claim 5, wherein the programming instructions are for execution by the at least one processor to:
provide an edge data network (EDN) configuration information to an EEC, the EDN configuration information indicating that the EES is allowed or not allowed to select one or more ACR scenarios.

10. The EES according to claim 9, wherein the programming instructions are for execution by the at least one processor to:
transmit an ACR selection notification to the EAS, the ACR selection notification indicting the one or more selected ACR scenarios for the edge application data session; and
transmit an ACR information notification to the EEC, the ACR information notification indicating the one or more selected ACR scenarios for the edge application data session.

11. An edge enabler client (EEC) for a communication system, comprising:
at least one processor; and
one or more memories coupled to the at least one processor and storing programming instructions for execution by the at least one processor to:
receive an application context relocation (ACR) information notification from an edge enabler server (EES) or a serving EES, the ACR information notification being associated with an edge application data session between an application client (AC) and an edge application server (EAS); and
select one or more ACR scenarios for the edge application data session when:
the ACR information notification indicates that the ACR is successful; and
the EES is not allowed to select one or more ACR scenarios for the edge application data session; or
transmit an ACR selection request to the EES when:
the ACR information notification indicates that the ACR is successful and that an EEC context relocation is unsuccessful; and
the EES is allowed to select one or more ACR scenarios for the edge application data session, the ACR selection request indicating a trigger for the EES to select one or more ACR scenarios for the edge application data session; or
receive an ACR information notification from the EES when:
the ACR information notification indicates that the ACR is successful and that the EEC context relocation is successful; and
the EES is allowed to select one or more ACR scenarios for the edge application data session, the ACR information notification indicating one or more selected ACR scenarios for the edge application data session.

12. The EEC according to claim 11, wherein the programming instructions are for execution by the at least one processor to, upon having selected the one or more ACR scenarios for the edge application data session:
transmit a ACR scenario message to the EES, the ACR scenario message indicating the one or more selected ACR scenarios.

13. The EEC according to claim 11, wherein the programming instructions are for execution by the at least one processor to, prior to transmitting the ACR selection request to the EES:
obtain an edge data network (EDN) configuration information from the EES, the EDN configuration information indicating that the EES is allowed or not allowed to select one or more ACR scenarios for the edge application data session.

14. The EEC according to claim 11, wherein the programming instructions are for execution by the at least one processor to, after having transmitted the ACR selection request to the EES:
receive the ACR information notification from the EES, the ACR information notification indicating one or more selected ACR scenarios for the edge application data session.

15. A method for an edge enabler server (EES), wherein the method comprises:
receiving an application context relocation (ACR) status update from an edge application server (EAS), the ACR status update being associated with an edge application data session between an application client (AC) and the EAS; and
selecting one or more ACR scenarios for the edge application data session when the ACR status update indicates that the ACR is successful.

16. The method according to claim 15, wherein the method comprises, previous to selecting the ACR scenario:
receiving an edge enabler client (EEC) context from a serving EES, the EEC context indicating at least one of a set of supported or previously selected ACR scenarios for the edge application data session; and
selecting the one or more ACR scenarios from at least one of the set of supported or previously selected ACR scenarios.

17. The method according to claim 16, wherein the method comprises at least one of:
storing the one or more selected ACR scenarios in the EEC context; or storing at least one of the set of supported or previously selected ACR scenarios in the EEC context.

18. The method according to claim 16, wherein the method comprises:
selecting the one or more ACR scenarios for the edge application data session when:
the ACR status update indicates that the ACR is successful; and
the EEC context indicates that an EEC context relocation is successful.

19. The method according to claim 18, wherein the method comprises:
selecting the one or more ACR scenarios for the edge application data session when:
the ACR status update indicates that the ACR is successful;
the EEC context indicates that the EEC context relocation is successful; and
the EES is allowed to select one or more ACR scenarios for the edge application data session.

20. The method according to claim 18, wherein the method comprises:
receiving an ACR scenario message from an EEC when the EES is not allowed to select one or more ACR scenarios for the edge application data session, the ACR scenario message indicating one or more ACR scenarios for the edge application data session; and
transmitting an ACR selection notification to the EAS, the ACR selection notification indicating the one or more ACR scenarios for the edge application data session.
